(19) United States
(12) Patent Application Publication
(10) Pub. No.: US 2025/0236542 A1
(43) Pub. Date: Jul. 24, 2025

(54) DEVICE AND METHOD FOR WATER ELECTROLYZER CAPABLE OF SIMULTANEOUS DESALINATION THROUGH NANOELECTROKINETIC ION CONCENTRATION POLARIZATION

(71) Applicants: ProvaLabs, Inc., Seoul (KR); SEOUL NATIONAL UNIVERSITY R&DB FOUNDATION, Seoul (KR)

(72) Inventors: Sung Jae KIM, Seoul (KR); Ji Hee PARK, Incheon (KR); Se Hyuk YOON, Seoul (KR); Sungjae HA, Seongnam-si (KR)

(21) Appl. No.: 18/991,342

(22) Filed: Dec. 20, 2024

(30) Foreign Application Priority Data
Jan. 18, 2024 (KR) 10-2024-0008272
Mar. 26, 2024 (KR) 10-2024-0041300
Nov. 12, 2024 (KR) 10-2024-0160525

(51) Int. Cl. C02F 1/469; B01D 61/46; B01D 61/54; C02F 1/461; C02F 103/08; C25B 1/04; C25B 9/19; C25B 15/029

(52) U.S. Cl. CPC C02F 1/4693; B01D 61/461; B01D 61/54; C02F 1/46104; C25B 1/04; C25B 9/19; C25B 15/029; B01D 2313/345; B01D 2315/10; C02F 2103/08; C02F 2201/4614; C02F 2201/46145; C02F 2209/05; C02F 2209/40

(57) ABSTRACT

Provided is an apparatus and a method of desalinating saltwater and transporting hydrogen ions using Ion Concentration Polarization (ICP), the apparatus including: a channel part including a channel allowing saltwater to be introduced thereinto, an ion-selective membrane connected to the channel, and a cathode and an anode for applying a voltage to both ends of the channel; a desalination part configured to obtain fresh water from the saltwater with ionic substances removed from the saltwater by ion concentration polarization in a first region adjacent to the anode of the ion-selective membrane; and a hydrogen gas production part configured to concentrate the ionic substances in a second region adjacent to the cathode of the ion-selective membrane and to reduce hydrogen ions (H⁺) contained in the ionic substances.

### CROSS-REFERENCE TO RELATED APPLICATION

This application claims priority to and the benefit of Korean Patent Application No. 10-2024-0008272, filed on Jan. 18, 2024, No. 10-2024-0041300, filed on Mar. 26, 2024, and No. 10-2024-0160525, filed on Nov. 12, 2024, the disclosures of which are incorporated herein by reference in their entirety.

### STATEMENT REGARDING PRIOR DISCLOSURES BY THE INVENTOR OR A JOINT INVENTOR

A non-patent literature entitled, “Simultaneous Desalination and Hydrogen Production by Nanoelectrokinetic Selective Ion Separation”, which was published on Nov. 19, 2023, is not a prior art under 35 USC 102 as being a disclosure made directly or indirectly by the inventor or a joint inventor 1 year or less before the effective filing date of the instant application. A copy of the non-patent literature prior disclosure is being submitted with the instant application in an Information Disclosure Statement pursuant to 37 CFR 1.97 and 1.98.

### STATEMENT REGARDING SPONSORED RESEARCH OR DEVELOPMENT

This invention was funded by the Ministry of Science and ICT (MSIT) of the Republic of Korea and supported by the National Research Foundation of Korea (NRF) under Project Unique No. 1711200490 and Project No. RS-2023-00302600.

### BACKGROUND OF THE DISCLOSURE

### Field of the Disclosure

The technical idea of the present disclosure relates to a water electrolysis device and method of removing suspended solids and producing freshwater using nanoelectrokinetic ion concentration polarization.

### Description of the Related Art

Lack of clean water and lack of energy are the most critical survival challenges facing humanity. Since the supply of clean water requires energy and the production of energy requires clean water, there is a strong nexus between them. To achieve carbon neutrality and sustainable development of humanity, technologies that can identify the nexus, the so-called “water-energy nexus” and utilize resources efficiently are needed.

Since evaporation and reverse osmosis, which currently dominates the market for the desalination processes to produce clean water, take high fossil fuel usage and plant construction costs, electro-membrane desalination using ion-exchange membranes is being actively researched to replace them. However, it is still energy intensive. Among the hydrogen gas production techniques to obtain energy from water, electrolysis is the most suitable technique in terms of mass production and economics, and techniques using ion-exchange membranes in a similar manner are being widely researched, but their efficiency is reduced if highly saline water such as seawater is used. In particular, water, such as seawater and brackish water, which can be obtained naturally contains various impurities, microorganisms, and small suspended substances. If it is used as is, these impurities may attach to a water electrolysis membrane and electrodes, which reduces the efficiency of a water electrolysis apparatus and shortens its lifespan.

In addition, an ion-selective membrane, which is the core of a water electrolysis apparatus, should selectively pass only protons (H⁺), but if other salt ions exist in high concentrations in seawater, etc., the selective permeability of the ion-selective membrane may decrease, which may lower the current efficiency. For these reasons, it is technically challenging to use seawater, etc. as a direct influent in a water electrolysis apparatus. Therefore, desalinated water, purified pure water, an acidic aqueous solution for use as a source of protons, or the like is generally used, and, to use seawater, brackish water, etc., it is necessary to purify seawater, etc. through a pretreatment system before using it.

### SUMMARY OF THE DISCLOSURE

Therefore, the present disclosure has been made in view of the above problems, and it is an object of the present disclosure to provide a method of minimizing the contamination of a water electrolysis device and increasing energy efficiency while removing suspended solids from saltwater and desalinating the saltwater while a water electrolysis apparatus by utilizing Ion Concentration Polarization (ICP). However, these objectives are exemplary, and the technical idea of the present disclosure is not limited thereto.

In accordance with an aspect of the present disclosure, the above and other objects can be accomplished by the provision of an apparatus of desalinating saltwater and transporting hydrogen ions using Ion Concentration Polarization (ICP).

The apparatus may include a channel unit including a channel allowing saltwater to be introduced thereinto, an ion-selective membrane connected to the channel, and a cathode and an anode for applying a voltage to both ends of the channel, a fresh water production unit to obtain fresh water from the saltwater with ionic substances removed from the saltwater by ion concentration polarization in a first region adjacent to the anode of the ion-selective membrane, and a hydrogen gas production unit to concentrate the ionic substances in a second region adjacent to the cathode of the ion-selective membrane and to reduce hydrogen ions contained in the ionic substances.

In one embodiment, the first region may include an ion depletion zone, and the second region may include an ion enrichment zone.

In one embodiment, the channel may include a first microchannel coupled to a side of the anode, and a second microchannel coupled to a side of the cathode and connected to a ground voltage.

In one embodiment, the ionic substances may include hydrogen ions (H⁺) and at least one of sodium ions (Na⁺), calcium ions (Ca²⁺), magnesium ions (Mg²⁺), and a combination thereof.

In one embodiment, the ion-selective membrane may be a Nafion membrane.

In one embodiment, a potential between 100 mV and 300 V may be applied to the first microchannel.

In one embodiment, the first microchannel may include a first inlet channel provided at one end with an inlet allowing the saltwater to be introduced therethough, and a first outlet channel allowing fresh water to be discharged therethrough and a second outlet channel allowing the remainder of the saltwater to be discharged therethrough, the first outlet channel and the second outlet channel branching off from the other end of the first inlet channel.

In one embodiment, the second microchannel may include a third outlet channel through which a concentrated saltwater containing the ionic substances delivered from the first microchannel is discharged.

In accordance with another aspect of the present disclosure, the above and other objects can be accomplished by the provision of a method of desalinating saltwater and transporting hydrogen ions using Ion Concentration Polarization (ICP).

The method includes: (a) providing an apparatus including a channel part, a desalination part, and a hydrogen gas production part, the channel part comprising a channel allowing a saltwater to be introduced thereinto, an ion-selective membrane connected to the channel, and a cathode and an anode for applying a voltage to both ends of the channel, the desalination part configured to obtain fresh water from the saltwater with ionic substances removed from the saltwater by ion concentration polarization in a first region adjacent to the anode of the ion-selective membrane, and the hydrogen gas production part configured to concentrate the ionic substances in a second region adjacent to the cathode of the ion-selective membrane and to reduce hydrogen ions (H⁺) contained in the ionic substances; (b) supplying saltwater to the first region; (c) applying a current having a coefficient (X) of 0.05 to 5 mA/(cm²·mM) calculated according to Equation 1 below between a positive electrode part, placed in the first region, and a negative electrode part, placed in the second region, to transport hydrogen ions in the first region to the second region; and (d) capturing hydrogen gas in the second region while obtaining freshwater, from which impurities have been removed, in the first region:

$$X = \frac{I}{AC} \qquad [ Equation 1 ]$$

where I: current (mA), A: area of ion-selective membrane (cm²), and C: concentration (mM) of saltwater.

In an embodiment, in step (c), a current having a coefficient (X) of 0.2 to 2 mA/(cm²·mM) may be applied.

In an embodiment, in step (c), a current having a coefficient (X) of 0.5 to 1 mA/(cm²·mM) may be applied.

In an embodiment, the first region may include an ion depletion zone, and the second region may include an ion enrichment zone.

In an embodiment, the ion-selective membrane may be a cation-selective membrane.

In an embodiment, as the current increases, pH of the second region may be lowered.

In an embodiment, in step (c), a magnitude of a current applied is actively controlled based on a concentration of the saltwater and a concentration (C_{desalted}) of the freshwater obtained in step (d).

In an embodiment, in step (b), a supply flow rate of saltwater may be actively controlled based on a concentration of the saltwater and a concentration (C_{desalted}) of the freshwater obtained in step (d).

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 illustrates a system for performing production of hydrogen gas and desalination simultaneously using electrohydrodynamic ion transport according to an embodiment of the present disclosure;

FIG. 2 is a drawing for explaining a saltwater desalination and hydrogen transport method using Ion Concentration Polarization (ICP) according to an embodiment of the present disclosure;

FIG. 3 illustrates a channel unit of FIG. 1 in more detail;

FIG. 4 schematically illustrates an apparatus for saltwater desalination and hydrogen transport according to an embodiment of the present disclosure;

FIG. 5 illustrates electrohydrodynamic ion transport in an apparatus for saltwater desalination and hydrogen transport according to an embodiment of the present disclosure;

FIG. 6 illustrates an embodiment of a three-dimensional electrolysis apparatus including the system of FIG. 2;

FIGS. 7A and 7B show the results of checking whether hydrogen and fresh water are produced simultaneously according to an embodiment of the present disclosure;

FIGS. 8A, 8B and 8C show photographs obtained by checking the transport of hydrogen ions and ion depletion zones in an apparatus for saltwater desalination and hydrogen transport according to an embodiment of the present disclosure;

FIG. 9 illustrates an implementation of an apparatus for saltwater desalination and hydrogen transport according to an embodiment of the present disclosure;

FIGS. 10A and 10B show the results of analyzing components of gas produced by the apparatus of FIG. 9 with a gas chromatograph.

FIG. 11 illustrates the production results of freshwater and hydrogen gas dependent upon a current magnitude when the water electrolysis apparatus of FIG. 6 is operated;

FIG. 12 illustrates the competitive transport of hydrogen ions and salt ions through an ion-selective membrane according to an embodiment of the present disclosure; and

FIG. 13 illustrates changes in a hydrogen gas production amount and a pH change amount when the charge amounts are identically controlled under constant current conditions according to an embodiment of the present disclosure.

### DETAILED DESCRIPTION OF THE DISCLOSURE

Hereinafter, one or more embodiments of the present disclosure will be described in detail with reference to the accompanying drawings. Embodiments of the present disclosure are provided to more completely explain the present disclosure to those skilled in the art, and the following embodiments may be modified in many different forms, but the scope of the present disclosure is not limited to the following embodiments. Rather, the embodiments are provided to make the disclosure thorough and complete and to fully convey the technical idea of the disclosure to those skilled in the art. In the drawings, the thicknesses and sizes of layers may be exaggerated for convenience and clarity of explanation.

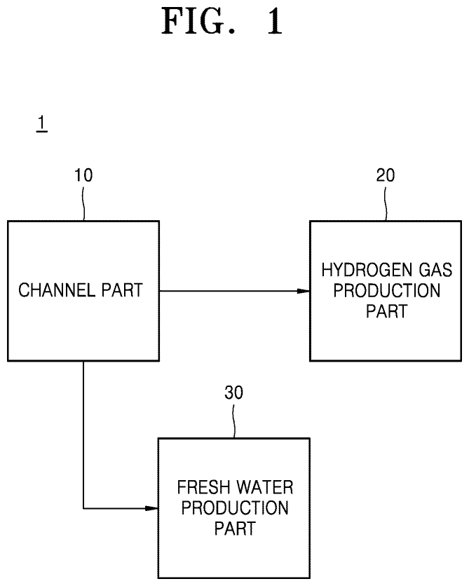

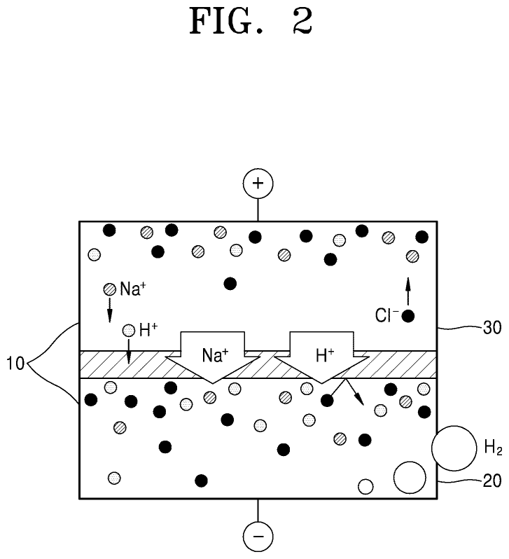

FIG. 1 illustrates a system for performing production of hydrogen gas and desalination simultaneously using electrohydrodynamic ion transport according to an embodiment of the present disclosure. FIG. 2 is a drawing for explaining a saltwater desalination and hydrogen transport method using Ion Concentration Polarization (ICP) according to an embodiment of the present disclosure.

Referring to FIG. 1 and FIG. 2, a system 1 for implementing a saltwater desalination and hydrogen ion transport method may include a channel part 10, a hydrogen gas production part 20 and a desalination part 30.

The channel part 10 is a passage through which saltwater flows, and an ion-selective membrane is provided between the channel part 10 to cause ICP. When current is applied to the channel part 10, ICP occurs in the vicinity of an ion-selective membrane, so that particles are separated from saltwater and discharged, and, at the same time, hydrogen ions are transported to and reduced in the hydrogen gas production part 20, and desalination is performed in the desalination part 30, thereby obtaining freshwater.

For the desalination, it is expected that the more salt ions pass through the ion-selective membrane, the better the desalination efficiency. On the other hand, for the hydrogen gas production using electrolysis, the production efficiency of hydrogen gas is improved only when a large amount of hydrogen ions pass through the ion-selective membrane. Therefore, the present disclosure provides an apparatus capable of desalination by utilizing an ion depletion zone around the ion-selective membrane, while hydrogen ions pass through the ion-selective membrane, while.

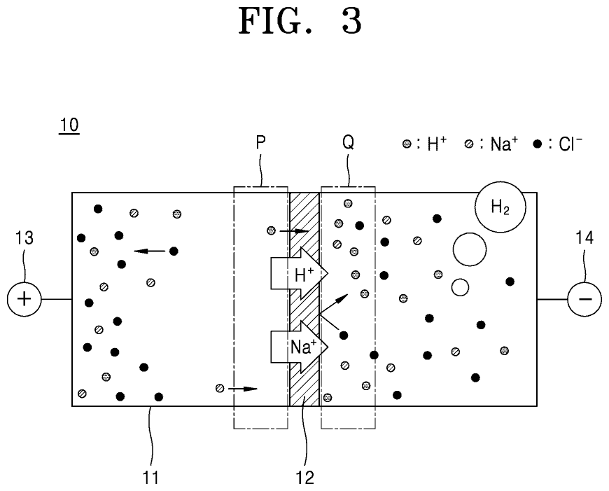

FIG. 3 illustrates the channel part of FIG. 1 in more detail. Referring to FIG. 3, the channel part 10 may include a microchannel 11, an ion-selective membrane 12, an anode 13, and a cathode 14.

The microchannel 11 may be configured in the form of a pipe, tube, or the like with a diameter on the scale of μm. The saltwater is introduced into and transported through the microchannel 11. In an embodiment, the microchannel 11 may have a shape elongated in a direction such that the saltwater can easily move along the path.

The saltwater refers to a variety of solutions containing sodium ions (Na⁺) and chlorine ions (Cl⁻), and may include, for example, seawater, brine, sewage treatment effluent, or salt-enriched wastewater.

The ion-selective membrane 12 selectively allows only specific ionic substances to pass therethrough and may be connected to the microchannel 11 at one or more contact points. The ion-selective membrane 12 may be a cationic permeable membrane capable of allowing hydrogen ions to pass therethrough. The ion-selective membrane 12 may be a material containing Nafion, which is a porous nanomaterial.

The anode 13 and the cathode 14 may be formed at one end and the opposite end of the microchannel 11, respectively. When an electric field is applied to the anode 13 and the cathode 14 across the ion-selective membrane 12, ions having the same polarity as the ion-selective membrane 12 are not allowed to pass through the ion-selective membrane 12, and only ions having the opposite polarity pass through the ion-selective membrane 12. As a result, an ion depletion zone P, in which electrolyte concentration is rapidly decreased, and an ion enrichment zone Q, in which electrolyte concentration is rapidly increased, are formed on both sides of the ion-selective membrane 12, which is referred to as ICP.

FIG. 3 illustrates ICP when the ion-selective membrane 12 is a cation-selective membrane. The cation-selective membrane selectively allows cations to pass therethrough and blocks anions.

Referring to FIG. 3, for example, the cation-selective membrane selectively allows cations such as hydrogen ions (H⁺) or sodium ions (Na⁺), which are alkali metal ions, to pass therethrough while not allowing chlorine ions (Cl⁻), which are anions, to pass therethrough.

As a result, ionic substances including hydrogen ions, sodium ions, and the like that have passed through the ion-selective membrane 12 are concentrated in the ion enrichment zone Q, and an ion depletion zone P is formed at an interface of the ion-selective membrane 12 on the side facing the anode 13.

Strong electrical repulsion occurs between ions that have not passed through the ion-selective membrane 12 and thus affects both cations and anions, resulting in an ion concentration gradient. In this case, a vortex is formed around the interface of the ion depletion zone P, and charged particles, cells, droplets, and the like are also affected by the electrical repulsion of ions at the interface of the ion depletion zone P and are pushed out of the vicinity of the ion-selective membrane 12.

A first region including the ion depletion zone P may be provided with the desalination part 30, where fresh water may be obtained with ionic substances removed. A second region including the ion enrichment zone Q may be provided with the hydrogen gas production part 20, where the ionic substances are concentrated and hydrogen ions contained in the ionic substances are reduced.

The ionic substances concentrated in the ion enrichment zone Q may include, in addition to hydrogen ions, at least one of sodium ions (Na⁺), calcium ions (Ca²⁺), magnesium ions (Mg²⁺), and a combination thereof. However, hydrogen ions may be reduced more easily than other cations by the hydrogen gas production part 20 because sodium ions (Na⁺), calcium ions (Ca²⁺), magnesium ions (Mg²⁺), and the like have much more negative reduction potentials than hydrogen ions.

Thus, by using ICP, the apparatus 1 for performing production of hydrogen gas and desalination simultaneously according to the present disclosure may provide a platform for extracting fresh water from the ion depletion zone P formed in the vicinity of the membrane facing the oxidation electrode while producing hydrogen at the reduction electrode.

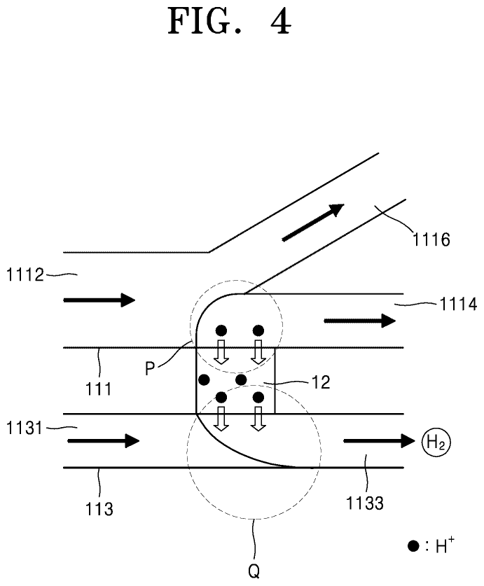

FIG. 4 schematically illustrates an apparatus for performing production of hydrogen gas and desalination simultaneously according to an embodiment of the present disclosure.

Referring to FIG. 4, the microchannel 11 may have a first microchannel 111 and a second microchannel 113 that are arranged in parallel.

The first microchannel 111 may include a first inlet channel 1112 provided at one end with an inlet allowing the saltwater to be introduced therethough, a first outlet channel 1114 through which fresh water is discharged, and a second outlet channel 1116 through which the remainder of the saltwater is discharged, the first outlet channel and the second outlet channel branching off from an opposite end of the first inlet channel 1112.

The ion-selective membrane 12 may be interposed between the first microchannel 111 and the second microchannel 113. Specifically, the first microchannel 111 may be disposed in contact with one side of the ion-selective membrane 12, and the second microchannel 113 may be disposed in contact with the opposite side of the ion-selective membrane 12.

The second microchannel 113 may include a third outlet channel 1133 through which a saltwater (or concentrated substances) containing the ionic substances delivered from the first microchannel 111 is discharged.

When an electric field is applied, ICP may occur near the point where the first outlet channel 1114 and the second outlet channel 1116 branch, resulting in the formation of the ion depletion zone P and the formation of the ion enrichment zone Q in a region of the second microchannel part 113 facing the ion depletion zone P.

In this case, hydrogen ions are transported from the first microchannel 111 to the second microchannel 113. Thus, a portion of the hydrogen ions may be discharged through the third outlet channel 1133, and the remaining portion thereof may be reduced and converted to hydrogen gas.

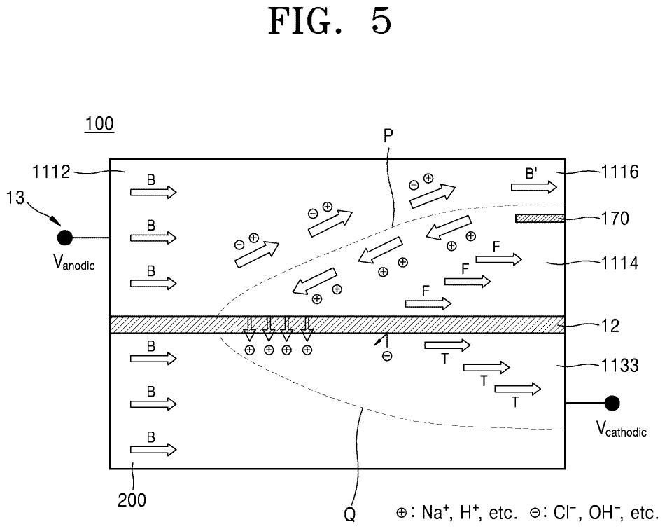

FIG. 5 illustrates electrohydrodynamic ion transport in an apparatus for performing production of hydrogen gas and desalination simultaneously according to an embodiment of the present disclosure.

In the first microchannel 111, a saltwater (e.g., seawater B) may be introduced through the first inlet channel 1112, and desalted fresh water F may be discharged through the first outlet channel 1114. The remainder substances B′ of the saltwater may be discharged through the second outlet channel 1116. The first microchannel 111 may be coupled to the anode 13. The first outlet channel 1114 and the second outlet channel 1116 may be physically separated by a branch 170, such as a channel wall.

In the second microchannel 113, a saltwater (e.g., seawater B) may be introduced through the second inlet channel 1131, and a saltwater T, which has been concentrated by receiving additional ionic substances from the first microchannel 111, may be discharged through the third outlet channel 1133.

The second microchannel 113 may be coupled to one side of the cathode 14 and may be connected to a ground voltage via the cathode 14. When an electric field is applied between the anode 13 and the cathode 14, ICP occurs, forming an ion depletion zone P and an ion enrichment zone Q.

The applied potential may be between 100 mV and 300 V. The size of the ion depletion zone P may depend on the potential difference. For example, as the voltage Vanodic applied to the anode 13 decreases, the amount of cations transported from the first microchannel 111 to the second microchannel 113 through the ion-selective membrane 12 may decrease, resulting in the weakening of the formation of the ion depletion zone, thereby reducing the desalination efficiency.

In contrast, as the voltage Vanodic applied to the anode 13 increases, cations are transported toward the ion-selective membrane 12, and the amount of cations transported from the first microchannel 111 to the second microchannel 113 may increase, but power consumption increases and efficiency of a water electrolysis apparatus may decrease. Therefore, the voltage Vanodic applied to the anode 13 is preferably in the range of 100 mV to 300.

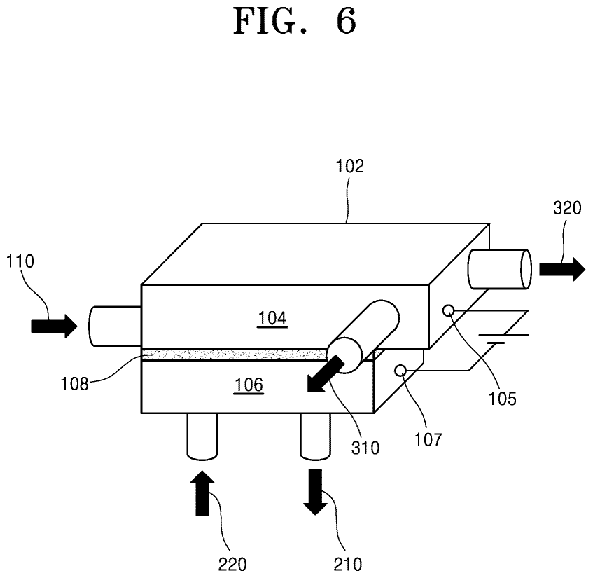

FIG. 6 illustrates an embodiment of a three-dimensional electrolysis apparatus including the system of FIG. 1 and FIG. 2.

Referring to FIG. 6, a first region 104 and a second region 106 are separated by an ion-selective membrane 108 and provided inside a housing 102. A saltwater supply stream 110 is supplied into the housing 102, a positive electrode part 105 is arranged in the first region 104, and a negative electrode part 107 is arranged in the second region 106. The first region 104 may correspond to the desalination part 30, and the second region 106 may correspond to the hydrogen gas production part 20.

Here, the housing 102 and pipes, tubes, etc. connected to the housing 102 may be macro channels with a diameter of mm, cm or more. An apparatus based on microchannels may show high desalination and hydrogen gas production efficiency on a small scale, but there may be limitations in expanding to an industrial scale. Therefore, it is desirable to form a macro channel that is advantageous for mass processing. However, the size of the channel part 10 according to the present invention is not limited, and may include both microchannels and macro channels.

Saltwater refers to various solutions containing sodium ions (Na⁺) and chlorine ions (Cl⁻), and may be, for example, a substance having a salt concentration of 0.1 to 35 g/L. Typically, it may be seawater.

The ion-selective membrane 108 selectively passes only specific ionic substances and, preferably, is a cation-permeable membrane that allows hydrogen ions to pass. The ion-selective membrane 108 may be a material including Nafion.

Various suspended solids exist in saltwater supplied to the first region 104, and these suspended solids need to be removed during a desalination process. Suspended solids in saltwater may include particulate matter, organic matter, inorganic matter, etc., and may be separated into and removed through a suspended-solid discharge stream 320 by ICP when current is applied.

As suspended solids in saltwater are discharged through the suspended-solid discharge stream 320, and salt ions move along the ion-selective membrane 108 to the second region 106, a fresh-water discharge stream 310 may be formed. The salt ions may include at least one of sodium ions (Na⁺), calcium ions (Ca²⁺), magnesium ions (Mg²⁺), potassium ions (K⁺), lithium ions (Li⁺) and combinations thereof.

Meanwhile, to provide constant electrical conductivity, it is preferable to use an electrolyte also in the second region 106, as in the first region 104. Accordingly, an electrolyte supply stream 220 may be injected into the second region 106. When sodium ions and hydrogen ions, etc. are transported from the first region 104 to the second region 106 through the ion-selective membrane 108, the amount of the transported ions is measured by ion chromatography, etc. Here, an electrolyte such as LiCl or KCl may serve as a reference material.

The hydrogen ions that have moved to the second region 106 may be reduced to form a hydrogen gas discharge stream 210.

The saltwater desalination and hydrogen transport method according to an embodiment of the present disclosure is described with reference to the apparatus of FIG. 2 as follows:

First, the ion-selective membrane 108 is placed inside the housing 102, and the housing 102 is divided into the first region 104 and the second region 106.

Next, saltwater is supplied to the first region 104 and the second region 106. In an embodiment of the present disclosure, it is preferable to supply saltwater having a salt concentration in the range of 0.1 to 35 g/L. In general, the average salt concentration of seawater is about 35 g/L, so according to an embodiment of the present disclosure, it may be used in a water electrolysis apparatus without pretreatment of seawater or concentration control through a separate circulation system.

The concentration of saltwater, i.e., a salt concentration, may affect a hydrogen generation reaction (reduction of H⁺) that occurs in the negative electrode part 107. Since saltwater contains an electrolyte such as NaCl, a current may be transmitted well as the salt concentration is high. However, when the salt concentration is too high, salt ions present in saltwater may inhibit the mobility of hydrogen ions and contaminate the ion-selective membrane in the water electrolysis apparatus.

Conversely, when the salt concentration is too low, the electrical conductivity may be decreased, which may reduce the current density, which may slow down the rate at which hydrogen ions move to electrodes or the electrochemical reaction rate required for hydrogen gas generation.

Accordingly, it is important to balance the ion movement and current density at an appropriate concentration range of 1 to 35 g/L. When the concentration of saltwater is appropriate, the electrical conductivity may be optimized to efficiently transmit current while reducing the contamination of the electrodes and ion-selective membrane.

Next, the positive electrode part 105 and the negative electrode part 107 are respectively connected to the first region 104 and the second region 106, and a current is applied to the positive electrode part 105 and a positive electrode part 105, so that hydrogen ions are transported from the first region 104 to the second region 106.

Current, which is an electrical characteristic affecting freshwater production and hydrogen ions transport according to an embodiment of the present disclosure, is one of the most important factors determining the efficiency and performance of electrolysis.

Unlike two-dimensional water electrolysis devices that rely on a planar design, a three-dimensional electrolysis apparatus has a three-dimensional fluid flow structure and complex flow structures in various directions, so it is desirable to apply a certain current or more for efficient ion transport. Here, the current plays a role in moving ions by an electric field under a given voltage. As the current increases, the charge moving per time (i.e., the amount of ion transport through the ion-selective membrane) increases.

In an electrolysis process, a current may vary depending on the area of ion-selective membrane, the concentration of saltwater, the distance between electrodes, a flow rate, a flow rate, etc. In particular, the current is greatly dependent on the area of ion-selective membrane and the concentration of saltwater.

As the area of the ion-selective membrane increases, the current density per unit area decreases even if the same current is applied, so the reaction rate may decrease. Therefore, the larger the area, the larger the current should be applied to maintain an appropriate current density. In addition, since more ions can pass through a large area, more current should be applied to maintain sufficient ion movement.

Meanwhile, the concentration of salt ions increases as the concentration of saltwater increases, so a current that can process more ions may be applied. The optimal current value at which the reaction occurs efficiently should be found by appropriately adjusting the current density without burdening the ion-selective membrane or the electrodes.

Accordingly, it is important to appropriately select the combination of a saltwater concentration, an ion-selective membrane area, and a current. In an embodiment of the present disclosure, a current is applied in a range where the coefficient (X) calculated by Equation 1 below is 0.05˜5 mA/(cm²·mM), preferably 0.2˜2 mA/(cm²·mM), more preferably 0.5˜1 mA/(cm²·mM):

$$X = I / AC \qquad [ Equation 1 ]$$

where I: current (mA), A: area (cm²) of ion-selective membrane, and C: concentration (mM) of saltwater.

When the coefficient (X) is lower than 0.05, multivalent cations such as Ca²⁺ or Mg²⁺ in saltwater may form hydroxides or carbonates and be deposited on an ion-selective membrane or an electrode surface. For example, precipitates such as CaCO₃ (calcium carbonate), Mg(OH)₂ (magnesium hydroxide) may cause membrane fouling and electrode corrosion, which may reduce hydrogen gas generation efficiency.

Conversely, if the coefficient (X) is higher than 5, power consumption increases and may hinder the efficient operation of a water electrolysis apparatus. For example, when a current becomes excessively high, the resistance of the entire system requires a larger potential, so power consumption increases.

Accordingly, to reduce unnecessary power consumption and efficiently maintain freshwater and hydrogen gas production reactions, it is important to apply an appropriate current that matches the area of the ion-selective membrane and the concentration of saltwater.

Additionally, in the present disclosure, it is important to actively control the supply flow rate of saltwater based on the concentration of the supplied saltwater (NaCl) and the concentration of the obtained freshwater. By appropriately controlling the supply flow rate of saltwater, the quality and production volume of freshwater may be maintained at a certain level or higher. For example, the salt concentration of freshwater is preferably 500 ppm or less as a commonly used standard for freshwater. Accordingly, when the salt concentration of the freshwater obtained in the present disclosure exceeds 500 ppm, it is desirable to control the concentration of the freshwater by actively controlling the supply flow rate of the saltwater as well as changing the current value according to Equation 1.

Hereinafter, the present disclosure is with reference to manufacturing examples and examples. However, the scope of the present disclosure is not limited to these manufacturing examples and examples.

### <Manufacturing Example 1>

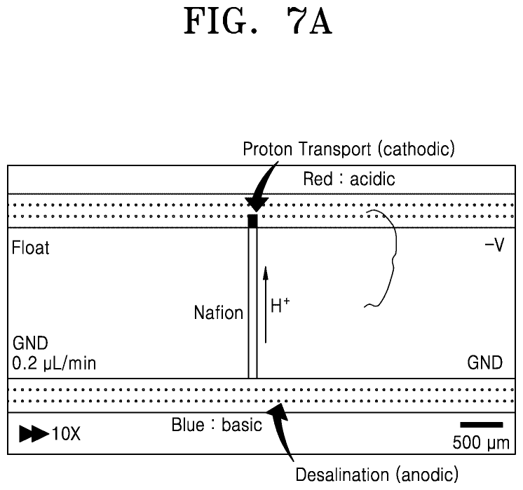

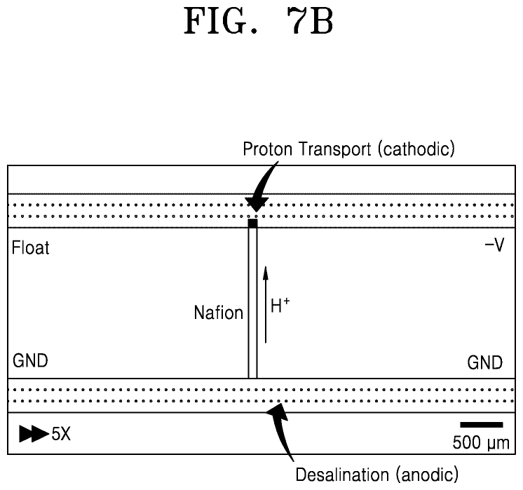

As shown in FIG. 7A, two straight microchannels were connected by a Nafion ion-exchange membrane, which is a cation-selective membrane. A pH indicator was placed in each channel, and a 10 mM potassium chloride (KCl) aqueous solution containing Alexa Fluor, a fluorophore, was continuously introduced into each channel with a syringe pump. A reduction electrode was connected to the upper one of the two channels, and the lower one of the two channels was connected to ground. FIG. 7B shows the same experiment as FIG. 7A, performed using a hydrochloric acid (HCl) solution in place of the potassium chloride (KCl).

### <Manufacturing Example 2>

A water electrolysis apparatus was manufactured as shown in FIG. 6, and a Nafion 211 membrane with a size of 1 cm² was installed. The Nafion membrane was placed between two platinum wire electrodes spaced apart from each other at an 8 mm interval. 20 mM NaCl was injected into a chamber, where an oxidation electrode was placed, using a syringe pump at a rate of 0.2 mL/min, and 20 mM LiCl was injected into a chamber, where a reduction electrode was placed, using a syringe pump at a rate of 0.2 mL/min. The supply of direct current was done using a DC power supply equipped with a voltmeter and an ammeter.

### Example 1

FIGS. 7 to 10 show the experimental results of checking whether hydrogen and fresh water are produced simultaneously according to the manufacturing example 1 of the present disclosure.

In FIGS. 7A and 7B, cations contained in the solution are transported from the lower channel to the upper channel connected to the reduction electrode. In the upper channel, it was observed that the color of the pH indicator changed to red near the ion enrichment zone (IEZ) around the Nafion membrane, which confirms that hydrogen ions have been transported through the Nafion membrane in both cases.

In FIG. 7A, it was observed that the color of the pH indicator changed to blue in the lower channel connected to an oxidation electrode, due to the remaining hydroxide ions (OH—) after hydrogen ions passed from the lower channel to the upper channel. This may also be evidence of the transport of hydrogen ion through the Nafion membrane.

In contrast, in FIG. 7B, no change in color of the pH indicator was observed in the lower channel connected to the oxidation electrode. This may be because the saltwater is not basic despite the transport of hydrogen ions, as acidic hydrochloric acid (HCl) solution was used in place of potassium chloride (KCl), a neutral salt.

Thus, it was demonstrated that acidic brine for hydrogen gas production is produced in the ion enrichment zone (IEZ) around the cation-exchange membrane and fresh water is produced in the ion depletion zone (IDZ).

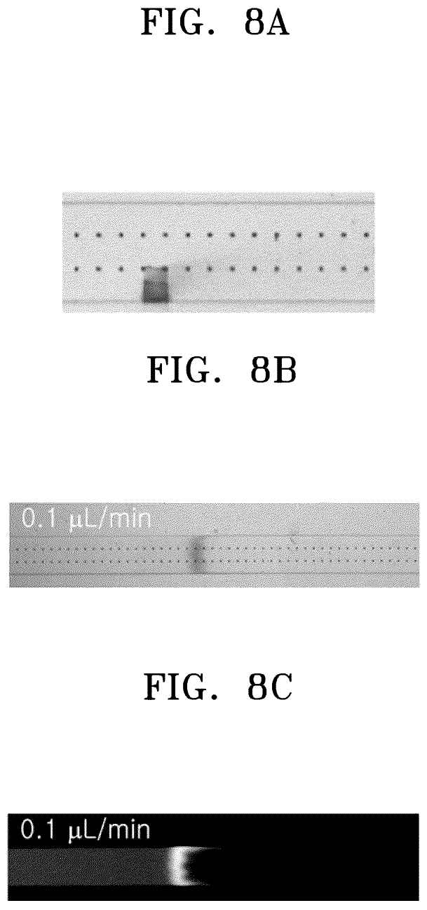

FIG. 8A shows solution acidification (color change of the pH indicator to red) due to the transport of hydrogen ions toward the reduction electrode, and FIG. 8B shows solution basification (change of the color of the pH indicator to blue) in the oxidation electrode side channel after the transport of hydrogen ions. In FIG. 8C, the ion depletion zone (black region not showing fluorescence) were observed.

In other words, simultaneously with the transport of hydrogen ions, the ion depletion zone (IDZ), in which the fluorescence signal disappears near the Nafion membrane, was identified in the lower channel on the oxidation electrode side (see FIG. 8C), and fresh water may be extracted from this zone.

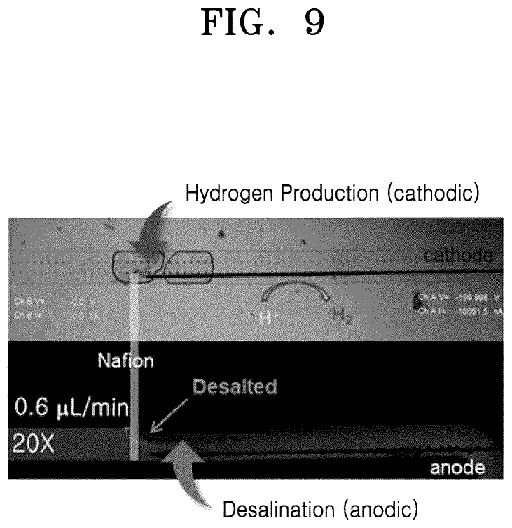

The results above together confirm the simultaneous production of fresh water and gas using ICP in the microchannel, as shown in FIG. 9.

In FIG. 9, when a reduction potential of +200 V was applied to the upper channel and a ground voltage was applied to the lower channel, bubbles were continuously generated at the reduction electrode (cathode) and flowed to the right along with the fluid flowing in from the left. With this gas generated, an ion depletion zone was identified near the cation-exchange membrane (Nafion), which demonstrates that a system for simultaneous production of fresh water and hydrogen using electrohydrodynamic ICP is implementable.

To identify the composition of the bubbles generated at the reduction electrode (cathode), argon (Ar), a carrier gas, was introduced into the apparatus of FIG. 9, and the discharged gas was collected and analyzed by gas chromatography.

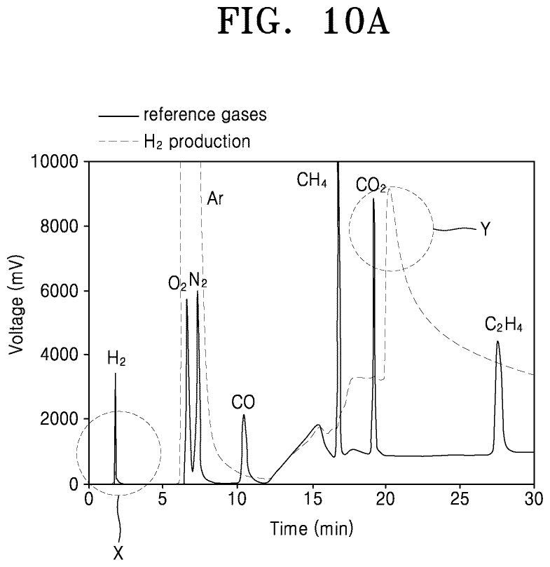

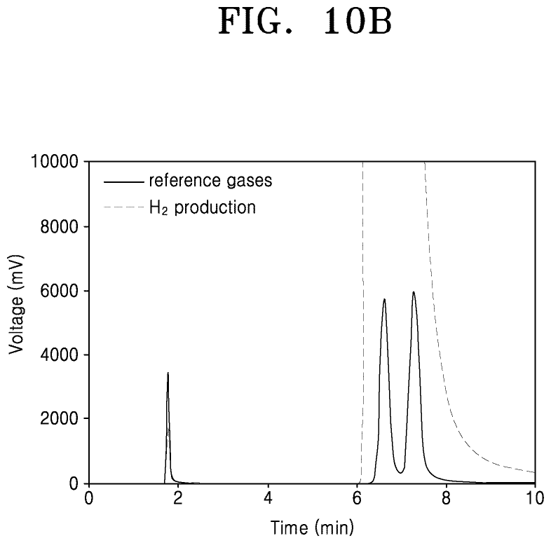

FIGS. 10A and 10B show the results of such a gas chromatographic analysis. FIG. 10A is a graph comparing the peak of hydrogen (H₂) with the peaks of other gases (reference gases), and FIG. 10B is an enlarged graph showing the hydrogen peak.

In FIG. 10A, it can be seen from the X region, hydrogen peak region, that hydrogen gas was produced at the reduction electrode. This demonstrates that a system that produces hydrogen using nanoelectrohydrodynamic ICP is implementable. For reference, the Y region may be considered as a baseline that appears when a large amount of argon, air, or the like is introduced, rather than as a peak of a specific substance.

### Example 2

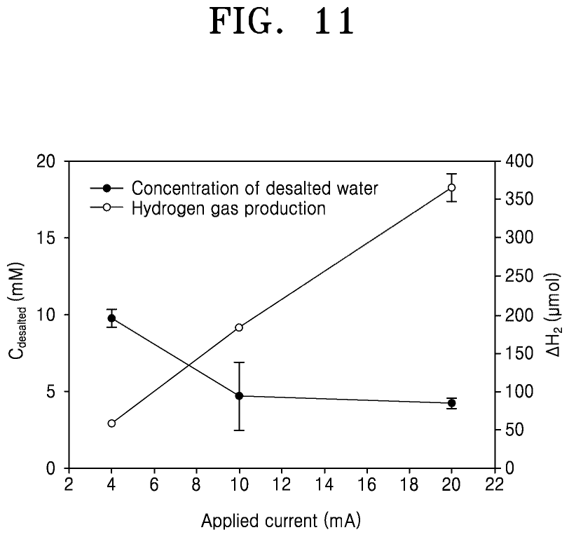

FIG. 11 illustrates the production results of freshwater and hydrogen gas dependent upon the current magnitude, in the water electrolysis apparatus according to the manufacturing example 2.

From FIG. 11, it can be seen that, when currents of 4 mA, 10 mA and 20 mA were respectively applied for 1 hour, the amount of hydrogen gas produced (ΔH₂) increases as the current value increases.

In addition, it can be seen that freshwater was produced by Ion Concentration Polarization (ICP) at all currents, but when it was 4 mA, the freshwater concentration exceeded a salt concentration of 500 ppm (about 8.56 mM), which is not desirable. In comparison, when the current value was 10 mA and 20 mA, the freshwater concentration (C_{desalted}) decreased, indicating that the quality of the freshwater was improved. However, as the freshwater concentrations at 10 mA and 20 mA were almost the same, it can be seen that it is most desirable to apply a current of 20 mA that was more advantageous for the hydrogen gas production reaction.

Accordingly, it can be seen that it is important to actively control the magnitude of the applied current based on the concentration of saltwater (NaCl) and the concentration of freshwater (C_{desalted}).

### Example 3

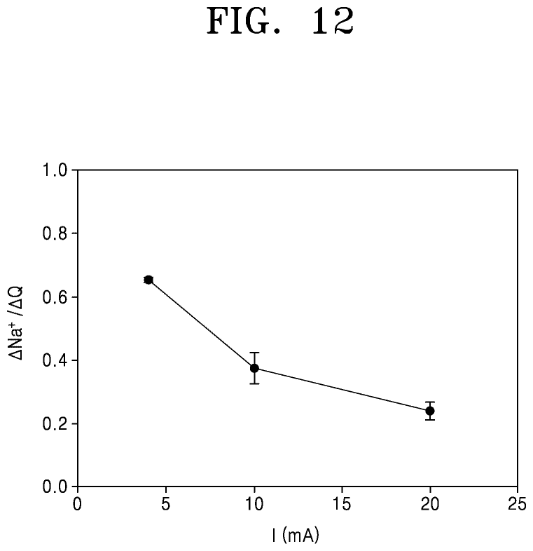

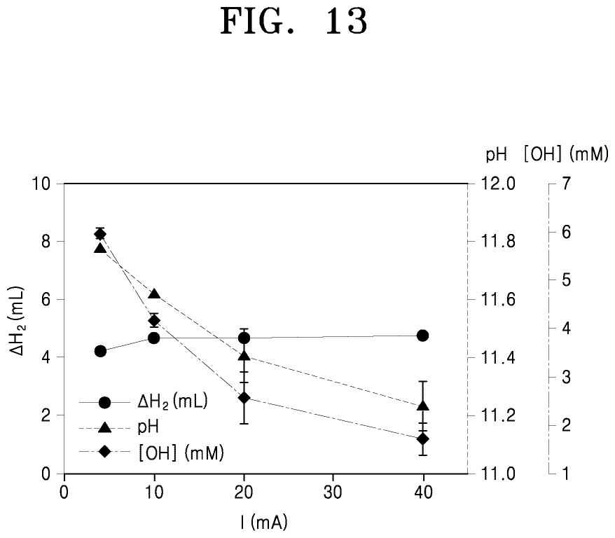

FIG. 12 illustrates the competitive transport of hydrogen ions and salt ions through an ion-selective membrane, in the water electrolysis apparatus according to the manufacturing example 2.

In FIG. 12, when 4 mA, 10 mA and 20 mA were respectively applied under constant current conditions, ion transport amounts dependent upon a current magnitude were compared. When the total movement amount of ions, which is the sum of the movement amounts of sodium ions (ΔNa⁺) and hydrogen ions (ΔH⁺) which account for the largest proportion of salt ions present in saltwater, is represented as ΔQ, ICP appeared differently depending upon the current magnitude. When the current was supplied for 1 hour, the movement amount of sodium ions to the total movement amount of ions moving through the ion-selective membrane (ΔNa⁺/ΔQ) was measured and displayed as a graph.

As shown in FIG. 12, at a current of 4 mA, the movement of Na⁺ ions is more dominant than that of H⁺ (ΔNa⁺>ΔH⁺). This means that the movement of other cations in the brine is smoother than that of hydrogen ions. In addition, as the hydrogen ions that can neutralize the OH⁻ ions generated after hydrogen gas production at the reduction electrode are less transported through the ion-selective membrane, the probability that multivalent cations such as Ca²⁺ and Mg²⁺ that may exist around the reduction electrode form hydroxides or carbonates and are deposited on the ion-selective membrane or the electrode surfaces increases.

When the current is 10 mA, the electric field becomes stronger and ion separation occurs, so the movement of H⁺ ions is more dominant than that of Na⁺ (ΔH⁺>ΔNa⁺). The total ion movement amount (ΔQ) may increase as the current increases. Among the ions passing through the ion-selective membrane, hydrogen ions have a very small size and high mobility, so they can move faster at the same current. As the current increases, hydrogen ions move faster, and sodium ions also move, but may move slower than hydrogen ions. Accordingly, the movement amount of hydrogen ions (ΔH⁺) increases as the current increases, but the movement amount of sodium ions (ΔNa⁺) increases little or nothing as the current increases, so the difference between the movement amount of hydrogen ions and the movement amount of sodium ions may become more distinct as the current increases.

When the current is 20 mA, the movement amount of hydrogen ions (ΔH⁺) increases and the movement amount of sodium ions (ΔNa⁺) decreases, compared to 10 mA, but the absolute value of the slope of the graph decreases.

If the current exceeds 20 mA, the resistance of the entire system requires a larger potential, which may increase power consumption.

Accordingly, to improve the movement amount of hydrogen ions through the ion-selective membrane, prevent the contamination of the ion-selective membrane or the electrodes, and reduce unnecessary power consumption, it is most desirable to apply a current value of 10 to 20 mA. In this case, the coefficient (X) calculated by Equation 1 is 0.5˜1 mA/(cm²·mM).

### Example 4

FIG. 13 illustrates comparison results of the hydrogen gas production amount (ΔH₂) and pH change amount when the charge amounts (Q) are controlled identically, in the water electrolysis apparatus according to the manufacturing example 2.

Here, the applied charge amount (Q) was controlled to be the same by applying 4 mA current for 2.5 hours, 10 mA current for 1 hour, 20 mA current for 0.5 hours, and 40 mA current for 0.25 hours. When using a Pt electrode, the Faradaic efficiency is close to 100%, so most of the charge amount (Q) flowing through the electrodes seems to be used for hydrogen gas production. Here, the purpose of controlling the charge amount is to control the hydrogen gas production amount to be the same so that the H⁺ consumption on the reduction electrode side due to hydrogen gas production is the same.

The concentration of the solution in the chamber where the reduction electrode was located was measured by ion chromatography, and the pH was measured with a pH meter.

The hydrogen gas production amount (ΔH₂) expressed on the y-axis of FIG. 13 is the value, quantitatively measured by gas chromatography, of the gas captured after the current was applied. As a result, the hydrogen gas production amount tended to increase slightly as the current increased, but it was almost the same.

Before the application of current, the initial pH of the solution on the side of the chamber where the reduction electrode was located was 5.58, but after hydrogen gas production, the pH in all the experimental examples increased to over 11 due to H⁺ consumption. However, despite the almost identical hydrogen gas production, it can be confirmed that the pH gradually decreases as the applied current increases. This means that, as the applied current increases, the amount of hydrogen ion transport through the ion-selective membrane increases, and the concentration of OH-generated due to hydrogen gas production at the reduction electrode decreases.

In addition, when comparing the OH-concentrations ([OH⁻]) of the solution on the y-axis, the OH⁻ concentration at 4 mA is about 3 times higher than the OH-concentration at 40 mA, and the production amount of cation precipitates increases as the OH concentration increases.

In addition, the hydrogen gas production amounts are almost the same even if the current increases, so it can be inferred that the current exceeding 40 mA is not desirable because the power consumption is excessive compared to the hydrogen gas production amount.

In summary of the results of FIG. 13, by increasing the current applied to the water electrolysis apparatus of the present disclosure, the transport of hydrogen ions through an ion-selective membrane is improved, thereby improving the supply of protons for hydrogen gas production. Further, by reducing the increase in pH after hydrogen gas production on the reduction electrode side, electrode contamination due to precipitation of other cations in saltwater may be prevented, thereby improving the durability and stability of the water electrolysis apparatus. Considering the power consumption amount, it is desirable to apply a current of 40 mA or less. Accordingly, the durability and long-term stability of the water electrolysis apparatus may be improved.

Finally, freshwater from which impurities have been removed is obtained through the fresh-water discharge stream 310 discharged from the first region 104, and, at the same time, hydrogen gas is captured through the hydrogen gas discharge stream 210 discharged from the second region 106.

In accordance with an embodiment of the present disclosure as apparent above, desalination and production of hydrogen gas may be performed simultaneously, the performance, durability, and long-term stability of a water electrolysis apparatus can be improved by minimizing contamination, which occurs during an ion transport process, of electrodes and an ion-selective membrane due to the use of an ion-selective membrane and increasing current efficiency.

The effects of the present disclosure described above are provided as examples, and the scope of the present disclosure is not limited by these effects.

Although the present disclosure has been described with reference to embodiments shown in the drawings, the embodiments are provided as only exemplary examples, and those skilled in the art will understand that various modifications and equivalent other embodiments are possible therefrom. Therefore, the true technical protection scope of the present disclosure should be determined by the technical spirit of the appended claims.

What is claimed is:

1. An apparatus of desalinating saltwater and transporting hydrogen ions using Ion Concentration Polarization (ICP), the apparatus comprising:
a channel part comprising a channel allowing saltwater to be introduced thereinto, an ion-selective membrane connected to the channel, and a cathode and an anode for applying a voltage to both ends of the channel;
a desalination part configured to obtain fresh water from the saltwater with ionic substances removed from the saltwater by ion concentration polarization in a first region adjacent to the anode of the ion-selective membrane; and
a hydrogen gas production part configured to concentrate the ionic substances in a second region adjacent to the cathode of the ion-selective membrane and to reduce hydrogen ions (H⁺) contained in the ionic substances.

2. The apparatus of claim 1, wherein the first region comprises an ion depletion zone, wherein the second region comprises an ion enrichment zone.

3. The apparatus of claim 1, wherein the channel comprises:
a first microchannel coupled to one side of the anode; and
a second microchannel coupled to one side of the cathode and connected to a ground voltage.

4. The apparatus of claim 1, wherein the ionic substances comprise hydrogen ions (H⁺), wherein the ionic substances further comprise at least one of sodium ions (Na⁺), calcium ions (Ca²⁺), magnesium ions (Mg²⁺), and a combination thereof.

5. The apparatus of claim 1, wherein the ion-selective membrane is a cation-selective membrane.

6. The apparatus of claim 3, wherein a potential between 100 mV and 300 V is applied to the first microchannel.

7. The apparatus of claim 3, wherein the first microchannel comprises:
a first inlet channel provided at one end with an inlet allowing the saltwater to be introduced therethough; and
a first outlet channel allowing fresh water to be discharged therethrough and a second outlet channel allowing the remainder of the saltwater to be discharged therethrough, the first outlet channel and the second outlet channel branching off from an opposite end of the first inlet channel.

8. The apparatus of claim 7, wherein the second microchannel comprises a third outlet channel through which a concentrated saltwater containing the ionic substances delivered from the first microchannel is discharged.

9. A method of desalinating saltwater and transporting hydrogen ions using Ion Concentration Polarization (ICP), the method comprising:
providing an apparatus including a channel part, a desalination part, and a hydrogen gas production part, the channel part comprising a channel allowing saltwater to be introduced thereinto, an ion-selective membrane connected to the channel, and a cathode and an anode for applying a voltage to both ends of the channel, the desalination part configured to obtain fresh water from the saltwater with ionic substances removed from the saltwater by ion concentration polarization in a first region adjacent to the anode of the ion-selective membrane, and the hydrogen gas production part configured to concentrate the ionic substances in a second region adjacent to the cathode of the ion-selective membrane and to reduce hydrogen ions (H⁺) contained in the ionic substances;
supplying saltwater to the first region;
applying a current having a coefficient (X) of 0.05 to 5 mA/(cm²·mM) calculated according to Equation 1 below between a positive electrode part, placed in the first region, and a negative electrode part, placed in the second region, to transport hydrogen ions in the first region to the second region; and
capturing hydrogen gas in the second region while obtaining freshwater, from which impurities have been removed, in the first region:
$$X = \frac{I}{AC} \qquad [ Equation 1 ]$$
where I: current (mA), A: area of ion-selective membrane (cm²), and C: concentration (mM) of saltwater.

10. The method according to claim 9, wherein, in the applying, a current having a coefficient (X) of 0.2 to 2 mA/(cm²·mM) is applied.

11. The method according to claim 9, wherein, in the applying, a current having a coefficient (X) of 0.5 to 1 mA/(cm²·mM) is applied.

12. The method according to claim 9, wherein the first region comprises an ion depletion zone, and the second region comprises an ion enrichment zone.

13. The method according to claim 9, wherein the ion-selective membrane is a cation-selective membrane.

14. The method according to claim 9, wherein, as the current increases, pH of the second region is lowered.

15. The method according to claim 9, wherein, in the applying, a magnitude of a current applied is actively controlled based on a concentration of the saltwater and a concentration (C_{desalted}) of the freshwater obtained in the capturing.

16. The method according to claim 9, wherein, in the supplying, a supply flow rate of saltwater is actively controlled based on a concentration of the saltwater and a concentration (C_{desalted}) of the freshwater obtained in the capturing.
